(19) United States
(12) Patent Application Publication
(10) Pub. No.: US 2026/0336008 A1
(43) Pub. Date: Oct. 29, 2026

(54) SYSTEMS AND METHODS FOR AUTOMATED CONTAINER ASSEMBLY MANUFACTURING

(71) Applicant: Melancon Holdings LLC, Lynchburg, VA (US)

(72) Inventors: Dennis Wayne Melancon, Lynchburg, VA (US); Charles Hendricksen, Fernandina Beach, FL (US)

(21) Appl. No.: 19/636,997

(22) Filed: Apr. 2, 2026

Related U.S. Application Data
(63) Continuation of application No. 19/061,882, filed on Feb. 24, 2025.
(60) Provisional application No. 63/556,479, filed on Feb. 22, 2024.
(60) Provisional application No. 63/571,817, filed on Mar. 29, 2024.

(51) Int. Cl. B23K 9/095; B23K 37/047; B23K 101/00; B25J 11/00

(52) U.S. Cl. CPC B23K 9/0956; B23K 37/047; B25J 11/005; B23K 2101/00

(57) ABSTRACT

An automated container manufacturing system, which includes a plurality of component manufacturing sections, a container assembly section, and a container welding section. The component sections include at least one robotic assembly arm and at least one robotic welding arm for forming container walls. The assembly section includes at least one robotic assembly arm and robotic welding arm for assembling and welding container walls to each other to form a container. The container welding section includes at least one robotic assembly arm for welding sections of a container.

### BACKGROUND OF THE INVENTION

The present invention relates to manufacturing a container, and more particularly to methods and systems for automated container manufacturing.

Containers, such as dumpsters and roll-off containers, are well known. They typically include a pair of side walls, a pair of end walls, and a bottom wall defining an inner chamber with an open upper end. Such containers are usually used to store waste, equipment, or other bulk items. There are numerous examples of such containers, some of which have a door or doors at one or both ends, tops that removably cover the open upper end, and side wall openings that allow for access into the inner chamber.

Preferably such containers are constructed to be transported from location to location, and easily lifted by a waste truck or tow truck. For instance, different containers can be used to haul waste from a work site to a landfill, to haul materials to be deposited at a work site, to haul equipment from a storage facility to a work site, or simply to house waste for collection by a waste truck.

The size and specifications of these containers make them challenging to manufacture, requiring individual attention to assembly of each container. This increases manufacturing time and costs. There is a need, therefore, to provide for automated manufacture of containers and container components.

### SUMMARY OF THE INVENTION

Accordingly, it is an object of the present disclosure to provide an automated container manufacturing system, which includes a plurality of component manufacturing sections, a container assembly section, and a container welding section. The component sections include at least one robotic assembly arm and at least one robotic welding arm for forming container walls. The assembly section includes at least one robotic assembly arm and robotic welding arm for assembling and welding container walls to each other to form a container. The container welding section includes at least one robotic assembly arm for welding sections of a container.

Preferably, the component manufacturing sections include a side wall section and floor section, each of which includes at least one handling robot and at least one welding robot configured to assemble and weld portions of container side walls and floors, respectively.

The welding robots of the container assembly section are configured to form tack welds.

In one embodiment, the container welding section includes at least two welding stations with each station including at least one robotic assembly arm and at least one robotic welding arm. Moreover, the two stations have a conveyer arranged therebetween for moving a container from one station to the other station. The welding section preferably includes a sensing station configured to scan a container for incomplete welded portions.

It is further an object of the present disclosure to provide a method and system for automated assembly of containers having at least a bottom wall and plurality of side walls. This includes a first robotic device configured to cut at least one sheet of metal into a bottom wall and a plurality of side walls, a second robotic device configured to arrange the bottom wall and plurality of side walls in spaced relation relative to a desired construction of a container, a third robotic device configured to connect the container bottom wall with the plurality of side walls, and a fourth robotic device configured to scan and analyze the connected walls to determine whether the walls are arranged accurately and securely connected.

In one embodiment, there further includes an additional robotic device configured to complete finishing welds for the container, an additional robotic device configured to clean the surfaces of the container, and at least one additional robotic device configured to paint or powder coat the surfaces of the container. Preferably, one robotic device is further configured to apply heat to the container.

### BRIEF DESCRIPTION OF THE DRAWINGS

The invention will be explained in greater detail below using embodiments with the aid of the accompanying figures in which:

FIG. 1 is a top view schematic of a first automated container manufacturing system according to the present disclosure;

FIG. 2 is a flow chart of a method for automated container manufacturing according to the present disclosure;

FIG. 3 is a perspective view of a container that is manufactured by the systems and processes of the present disclosure;

FIG. 4 is a top view of an automated container manufacturing system with dual tracks according to the present disclosure;

FIG. 5 is a top view of an automated container manufacturing system with a single track according to the present disclosure;

FIG. 6 is a top perspective view of the system of FIG. 2;

FIG. 7 is a schematic of an automated container manufacturing system according to the present disclosure;

FIG. 8 is a schematic of a first large container welding line of the system of FIG. 7;

FIG. 9 is a schematic of a second large container welding line of the system of FIG. 7;

Fug, 10 is a schematic of a small container welding line of the system of FIG. 7;

FIGS. 11 and 12 are front and perspective views, respectively, of a small container, handling robots and a welding robot according to the system of FIG. 7;

FIG. 13 is a perspective view of a handling robot and container according to the system of FIG. 7;

FIGS. 14 and 15 are front and perspective views of a large container with bracket;

FIGS. 16 and 17 are perspective views of welding points for small and large containers, respectively;

FIGS. 18-23 are schematics of a small container automated container manufacturing system according to the present disclosure;

FIG. 24 is a flow chart of a method for manufacturing small containers with the system of FIGS. 18-23;

FIGS. 25-37 are schematics of a large container automated container manufacturing system according to the present disclosure;

FIG. 38 is a a flow chart of a method for manufacturing large containers with the system of FIGS. 25-37;

FIGS. 39 and 40 are perspective views of a pair of handling robots and a small container bottom wall staging area;

FIGS. 41-47 are perspective views of handling robots and a small container staging area;

FIGS. 48-50 are perspective views of welding robots tack welding a small container;

FIGS. 51-54 are perspective views of small containers and welding robots completing finishing welds on the containers;

FIGS. 55 and 56 are bottom and top perspective views, respectively, of manufactured containers and an exit conveyer; and

FIGS. 57-66 are perspective views of a method for manufacturing containers according to the systems of the present disclosure;

### DETAILED DESCRIPTION

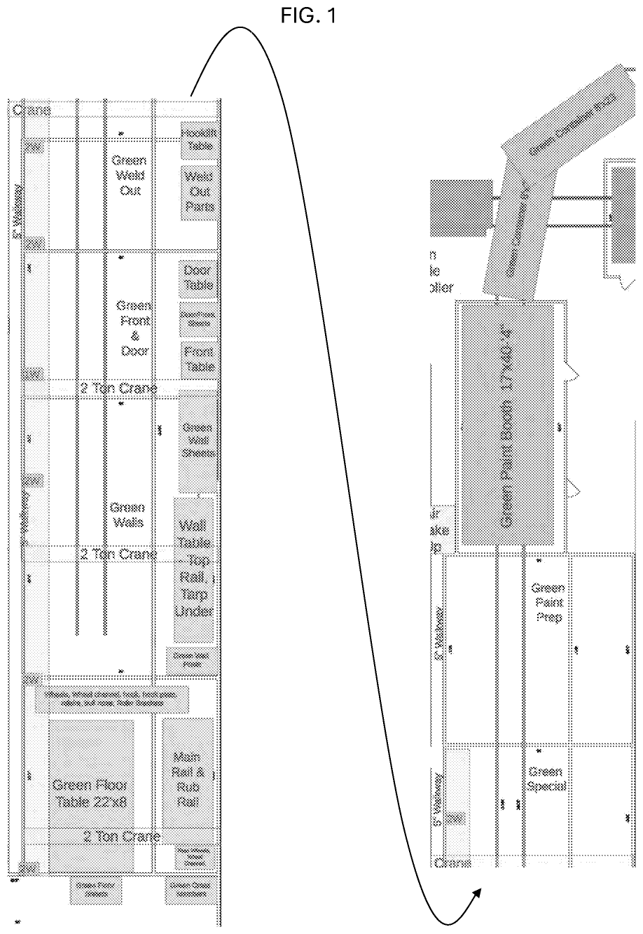

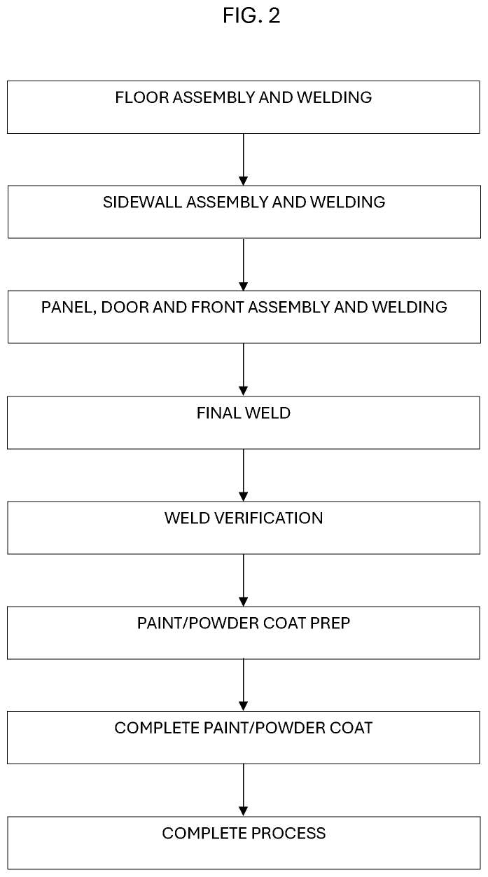

Referring first to FIGS. 1 and 2, there is a first embodiment of a system and method, respectively, of automated container assembly manufacturing. First the container portions are prepared, including forming the floor by welding at least two floor sections together, and forming the sides by welding at least two side wall sections together. A robotic arm autonomously completes the welds. The sections are then assembled by robotic arms being programmed to autonomously tack weld the sides of the container floor to container side walls and the front and rear of the container floor to container front and rear walls, respectively.

Once tack welds are completed, the container is fully welded, including welding the inner interfaces between the floor and the side and front walls, welding the outer interfaces between the floor and the side and front walls, welding the inner interfaces between the side walls and the front and rear walls, and welding the outer interfaces between the side walls and the front and rear walls. All of these welds are complete via robotic welding arms that have been programmed to autonomously complete the welds.

Preferably, there is an automated and robotic floor assembly and welding cell. This is where the materials begin to be assembled. Robotic arms select the materials and place them in position for welding, which is complete by the welding robots to finish the floor assembly.

There are then two cells for robotic assembly and welding of side walls. One of the cells is for the robotic arms to position the materials and weld the side walls. The other is for placing the side walls onto the floor section where they will be welded into position by the robotic welders.

There are also two cells for robotic placement and welding panels, door and the container front. The first is for placing material and welding the front wall, pan, top, roof and/or constructing a ramp wall with or without barn doors. The other is for welding the front wall and ramp/door onto the container.

A final welding robotic cell provides finishing welds as needed, and then the container is moved to a verification cell. This cell will use robotics with sensors to examine all the welds and the completed container before allowing the container to move to a painting or powder coating cell.

Once the container is complete and verified, it is moved to the paint and/or powder coating preparation cell. At this cell, the container is cleaned and the material is prepared for paint or powder coating. This is also completed by robotics that have been programmed to clean and prepare the container material. This will be a cleaning cell for preparing for paint or powder coating.

The container is moved to the paint and/or powder coating cell where robots will paint or powder coat all surfaces of the container and then dry/bake the container for a specified time necessary to set the paint/powder coat.

Following this, the finished product is removed from the process and stored for shipment.

As noted above, the container manufacturing facility is automated and integrated utilizing robotics, conveyers, cutters, cranes, intelligent moving floors, pulley systems and more. The process will be fully automated from raw materials to a powder-coated or painted containers. Processes that will not be automated include stacking the inventory of raw materials, maintaining the robotics and automated systems, and moving the final product away from the production line to be staged for shipping, which will be completed by individuals with or without machine assistance. The containers detailed herein are preferably those known as roll-off containers, waste containers, and/or dumpsters.

In addition to the container manufacturing process detailed above, container kits can be formed which are manufactured and packaged for assembly at a remote location. These include the assembled floor, sidewalls, front wall, and ramp/barn door that are painted or powder-coated before final assembly. These are stacked for shipping to manufacturers across the country for final assembly. This will allow for more units on a single truckload for improved shipping of the container kits from the facility to remote locations.

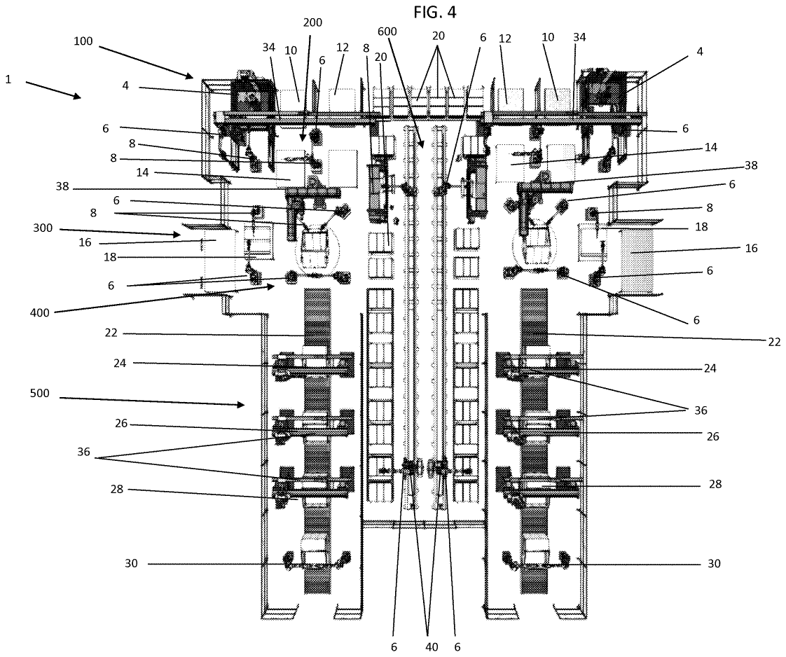

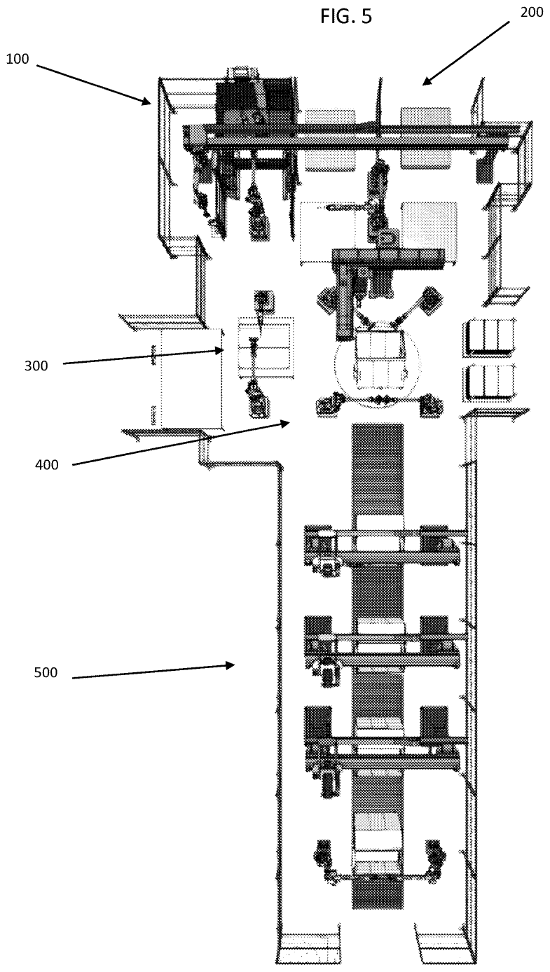

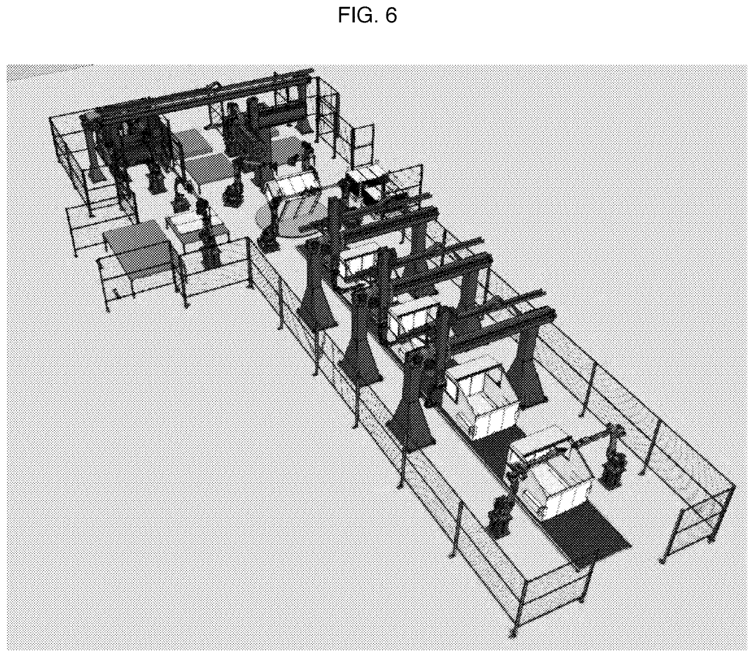

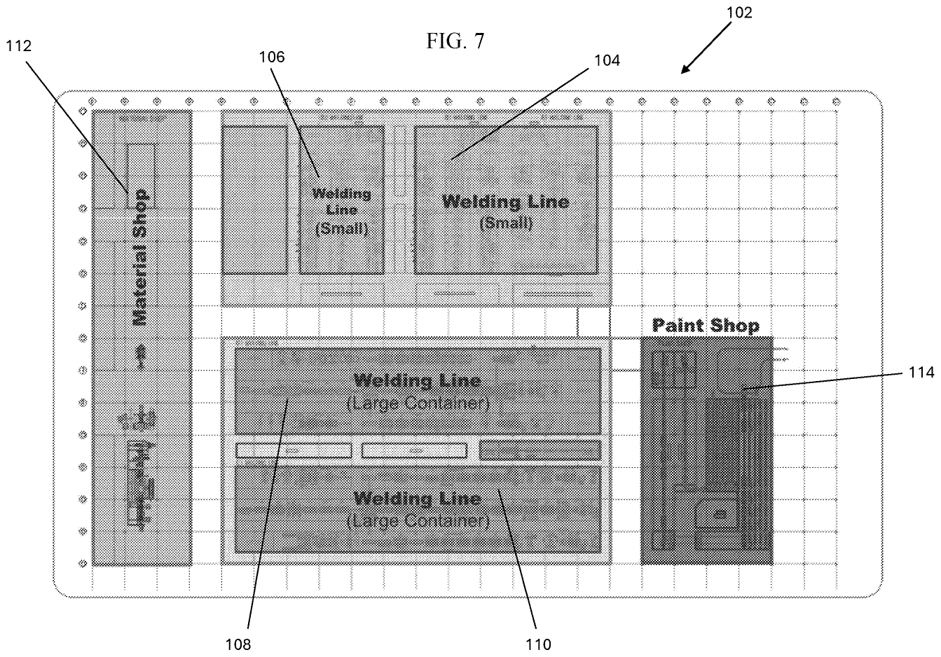

Referring to FIGS. 4-6 , there is a second embodiment for an automated container manufacturing system 1 with a plurality of manufacturing and assembly sections 100, 200, 300, 400, 500, 600, which are designed and arranged to manufacture containers, such as those used to retain waste, debris, machinery, or other materials. Each of these sections includes automated devices, such as laser cutters, robotic assembly arms and robotic welding arms, all of which are programmed to autonomously carry out cutting, assembling and welding processes, respectively. Such devices are shown in FIGS. 7 and 8.

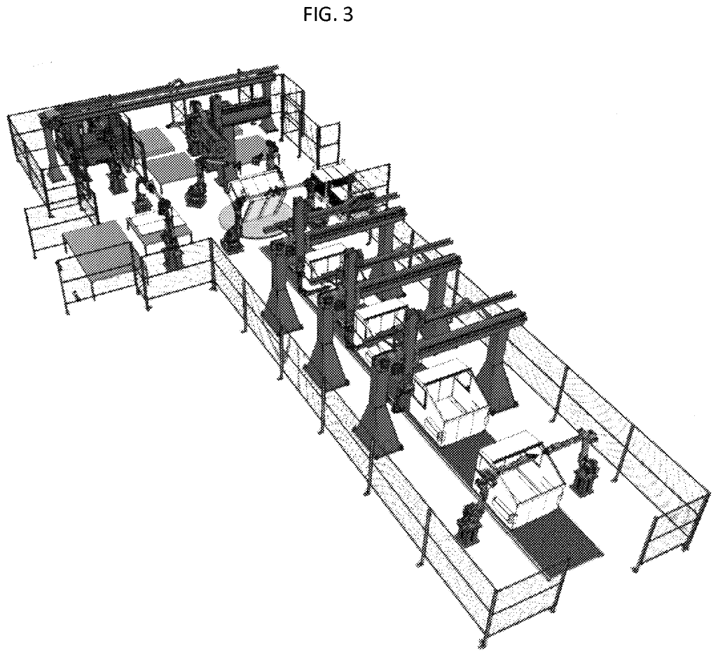

Preferably, the containers manufactured herein are roll-off containers, or similar containers, such as the one shown in FIG. 3. They include a bottom wall, side walls, a rear wall and a front wall, defining an inner chamber. The container shown in FIG. 3 has an open upper end, but it will be understood by those with skill in the art that the upper end could include a rigid or flexible top wall. Such containers are preferably made of a strong metal, such as steel. However, it will be understood by those with skills in the art that other known materials could be used such as fiberglass or other polymer materials. The front wall includes a ramp which can be pivoted down to an open position.

As noted, and shown in FIG. 4, the automated container manufacturing system 2 is divided into six assembly sections. This is for a dual assembly system, wherein two container assembly systems are provided. As shown in FIGS. 5 and 6, there may also be a single assembly section. The following description applies to both a dual and single assembly system, though the single assembly system shown in FIGS. 5 and 6 does not include a bending section 600, as described below and shown in FIG. 4. It will be understood by those with skill in the art that, while FIGS. 5 and 6 do not show a bending section 600, a single assembly system could include a bending section.

Referring to FIGS. 4-6, there is a fork pocket assembly 100 which includes at least one material cutter 4, at least one robotic assembly arm 6 and at least one welding robot 8. The cutter prepares raw material 10 by cutting it into sections configured to form a fork pocket, the robotic assembly arm assembles the sections for welding, and the welding robot welds all sections together. The fork pocket is ready for attachment with a container.

There is a side wall assembly section 200 which includes a robotic assembly arm 6 and at least one welding robot 8. The robotic arm selects raw material from a side wall supply 12 and places the material on an assembly table 14 for welding. The welding robot makes all necessary welds to form a side wall. Alternatively, the side walls could be preassembled and thus do not need to be constructed but only need to be welded to the bottom, front and rear walls.

Once a side wall is formed, a fork pocket from the fork pocket assembly 100 is welded to a side wall. The side wall is then passed on to a container assembly section 400 for assembly of a container. Preferably all welds during the side wall assembly process are complete welds to form the side walls. Alternatively, the side wall welds could be tack welds with final welds to be completed later in the process.

There is a floor assembly section 300 which includes a robotic assembly arm 6 and a welding robot 8. The robotic assembly arm selects raw material from a floor supply 16 and places the material on an assembly table 18 for welding. The welding robot makes all necessary welds to form the floor, and the complete floor is passed on to the dumpster assembly section 400. As with the side walls, the floor weld process is preferably complete prior to passing the floor on to the dumpster assembly process. It will be understood by those with skill in the art that the floor welds at this stage could be tack welds.

As shown in FIG. 3, there are guide rails attached to the bottom of the container. These are preferably connected to the container bottom wall during this step, though they could be welded thereto once the container is assembled.

The container assembly section 400 includes three robotic assembly arms 6 and one welding robot 8. The assembly arms select side walls, a floor, a front wall, and rear walls 20 from their respective sections for assembly. Each portion of the container is arranged in its proper place and the welding robot completes all initial welds to form the container. The welds formed here preferably include tack welds to form the container but not finalize the welds. The container is now ready for the final weld stage.

As shown in FIG. 3, the front ramp wall includes a pair of pivot shafts connecting the lower end of the ramp wall to a lower front end of the container. There are also torsion springs arranged around each pivot shaft. This container is further disclosed in U.S. Pat. No. 9,884,575, which is incorporated herein in its entirety. During assembly, these elements are arranged together and welded by the associated robots. It will be understood by those will skill in the art that other front walls and accessible doors could be provided, such as barn doors, which are handled and assembled by the assembly arms 6.

The final weld section 500 of the system is provided to finalize all welds and ensure the container is ready for use. This section includes a conveyor belt 22 and four welding stations 24, 26, 28, 30. The tack welded containers from the container assembly section 400 move down the conveyor belt and through each station sequentially. The floor weld station 24 uses robotic handling units 6 and robotic welding arms 8 to finalize the tack welding on the floor section. The second station, the inside welding station, also uses handling 6 and welding 8 robotics to finalize tack welding on the inside of the container. The third station, the outside welding station, finalizes tack welding on the outside of the container, again with handling 6 and welding 8 robotics. The fourth and final station, the quality control station, uses robotic sensor arms 32 which scan the container to verify quality control and that all welds are complete. If any welds are insufficient, the robots at this station provide further welds and/or the container is routed back to a previous weld station to complete an incomplete weld.

As shown in FIG. 4, there may also be a part bending section 600 which includes assembly robots 6 for bending any material as needed for a container.

As is shown in FIGS. 4-6, there is a single-axis gantry 34 used with the handling robot 6 of the pocket assembly 100 and wall assembly 200 sections, there is a two-axis gantry 36 used with the handling 6 and welding 8 robots of the final weld section, there is three-axis gantry 38 used with the handling 6 and welding 8 robots of the container assembly section 400, and there is a robot transport unit 40 which move handling robots 6 on a linear path.

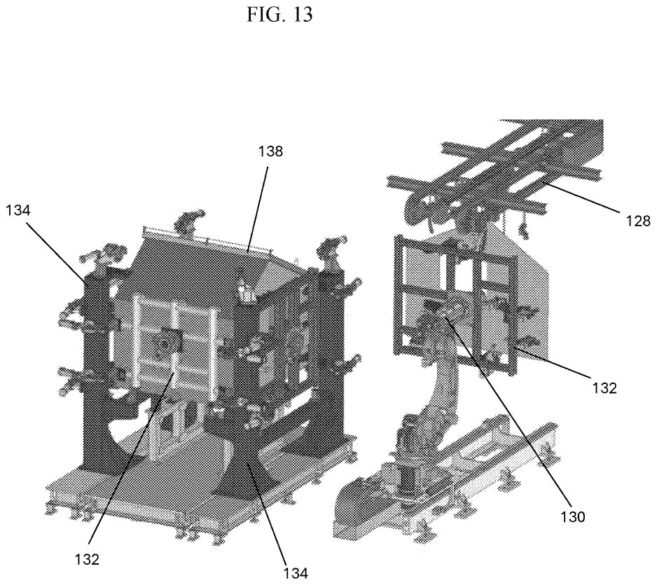

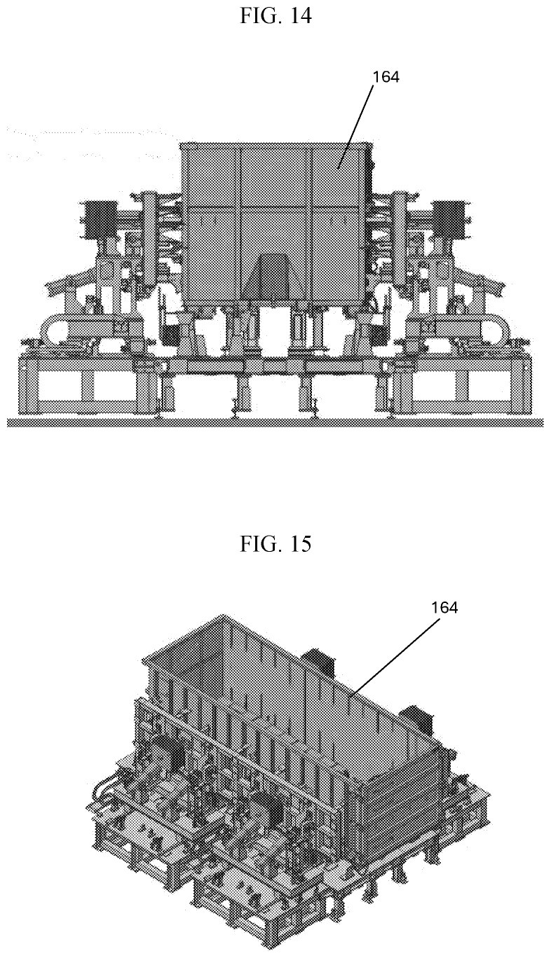

Referring now to FIG. 7-17, another embodiment of an automated container manufacturing system 102 is shown. This system includes a system and process for manufacturing small and large containers. There are first and second small container welding sections 104, 106, first and second large container welding sections 108, 110, a materials shop section 112 and a paint shop section 114.

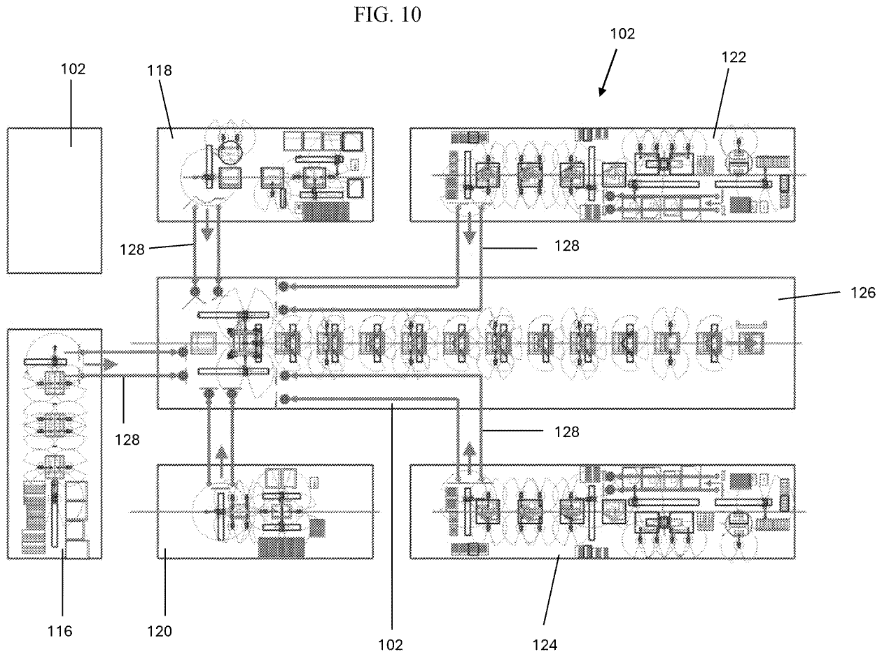

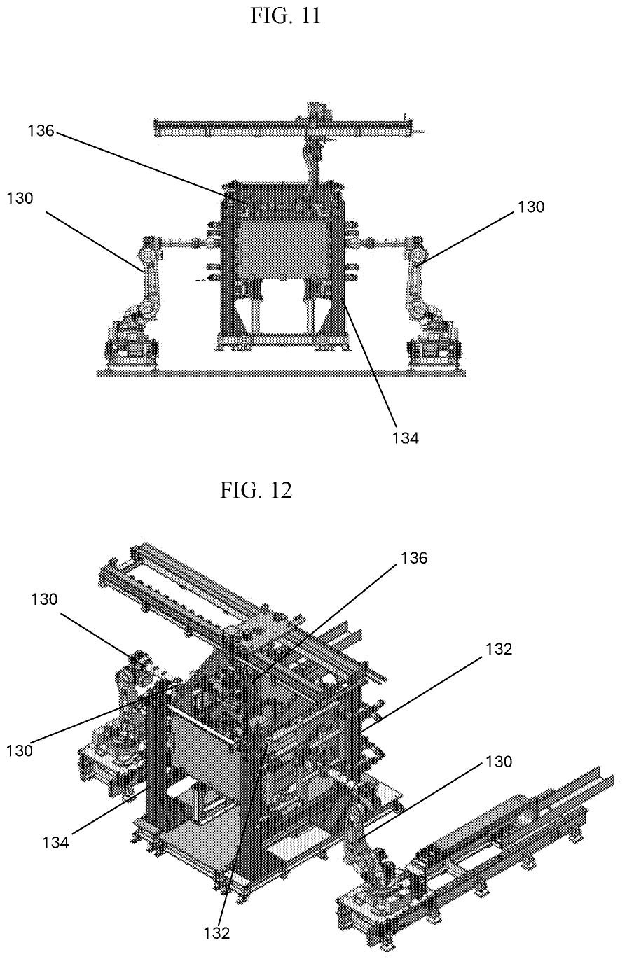

As shown in FIG. 10, the small container welding sections 104, 106 include a floor assembly section 116, front 118 and rear 120 panel sections, left 122 and right 124 panel sections, and a main section 126. The floor, front, rear and side panels of a container are prepared in their respective sections, which could include cutting openings in side panels, attaching handles, doors or other additional elements to panels, or simply arranging portions of a container for assembly. Conveyers 128 transport container portions to the main section for assembly. As shown in FIGS. 11-13, container portions are arranged via handling robotic arms 130, suction tools 132, container supports 134, and welding robots 136 to form containers 138.

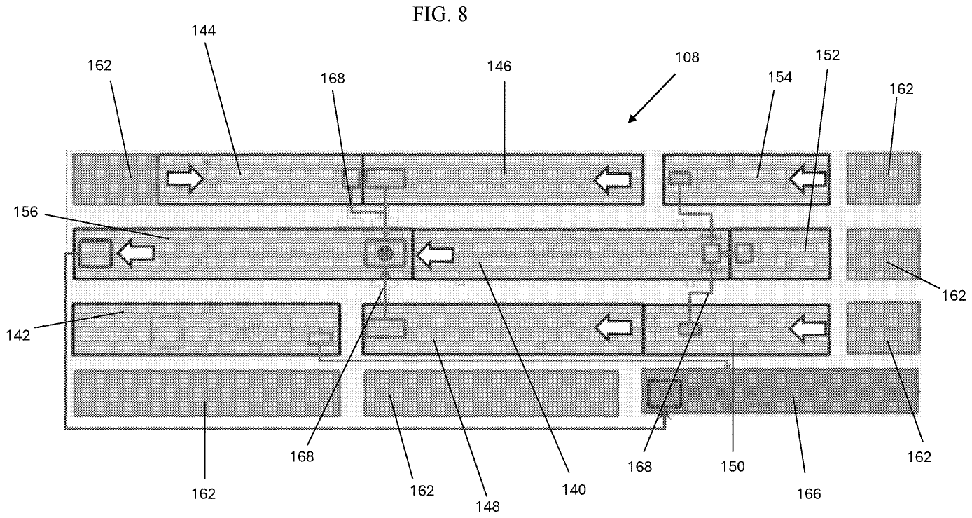

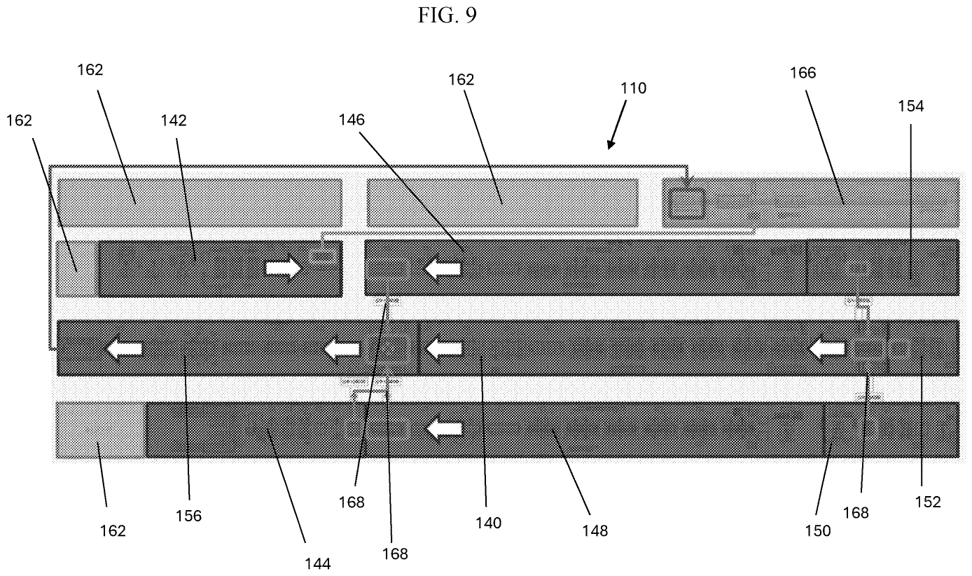

FIGS. 8 and 9 show details related to the large container welding sections 108, 110. There is a floor panel section 140, door assembly section 142, front panel section 144, right 146 and left 148 side panel sections, center 150, rear 152 and front 154 sub center sections, and a main section 156 where individual components are assembled to form a large container 158. Conveyors 160 are arranged between sections and led to the respective sections wherein a container component is assembled together with other components. Buffer sections 162 are arranged throughout the system to ensure all components are constructed as needed and manufacturing continues uninterrupted. Once all components are arranged and welded, the container 164 is transported to the metal finishing section 166 at which point the container door is attached. This is preferably completed via conveyors 168 and handling robots.

FIGS. 16 and 17 show preferred welding points 170 for small and large containers according to the manufacturing systems and methods of the FIGS. 7-15.

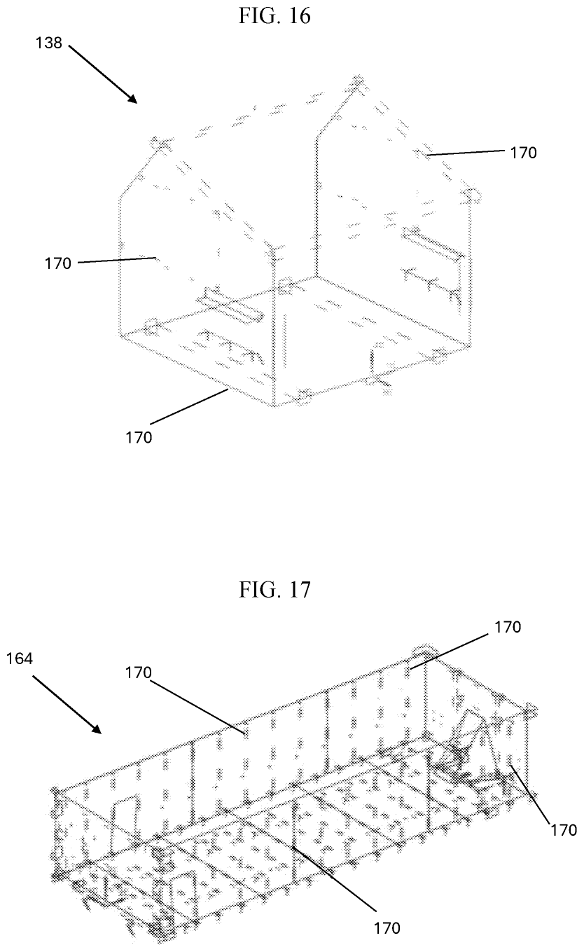

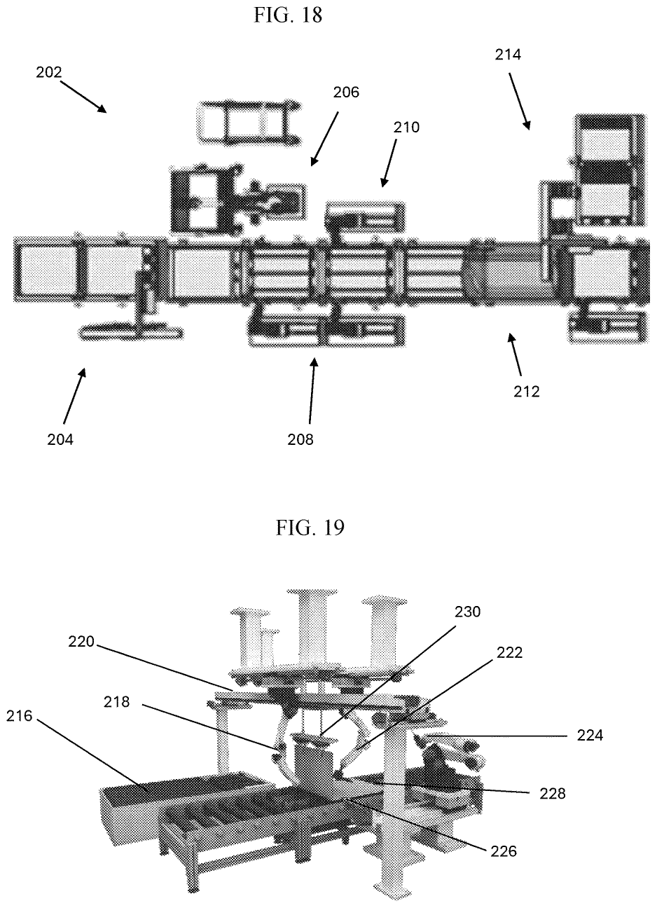

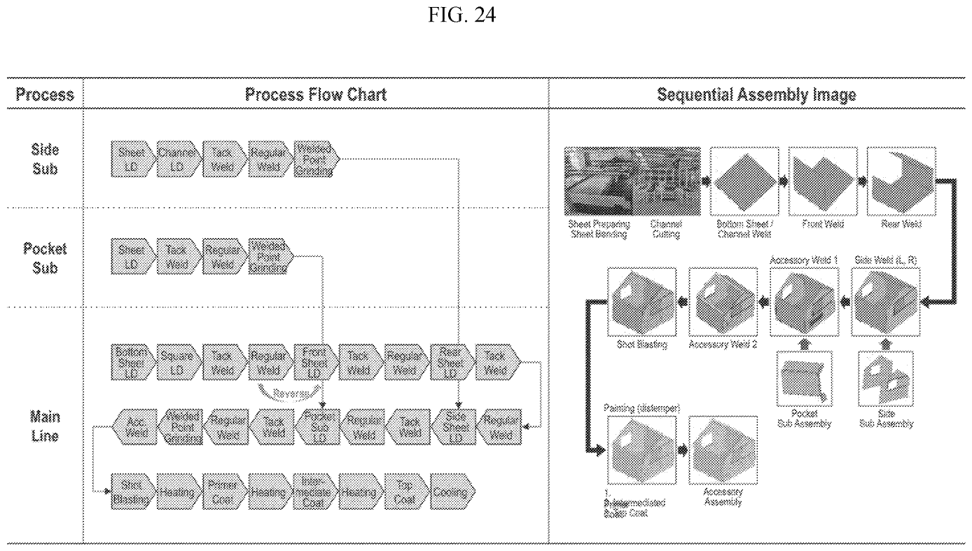

FIGS. 18-24 include an alternative system for manufacturing small containers. FIG. 18 shows a base frame and front shield weld station 202, which includes a transfer plate supply 204 to supply base plates, a frame loader 206 to supply base frames, a tack welding portion 208, a regular welding portion 210, a reverse turn 212 where base frame parts are turned or flipped, and a front sheet welding section 214 to supply and weld front sheets. This station prepares and welds the base frame and front shield of a small container.

FIG. 19 shows a front sheet assembly unit which includes a front sheet aligner 216, base outside jig 218, sheet supply transfer 220, base inside jig 222, front sheet inside point welder 224, centering mechanism 226, and flexible stopper 228 and a component handler 230. This unit is used with station 202.

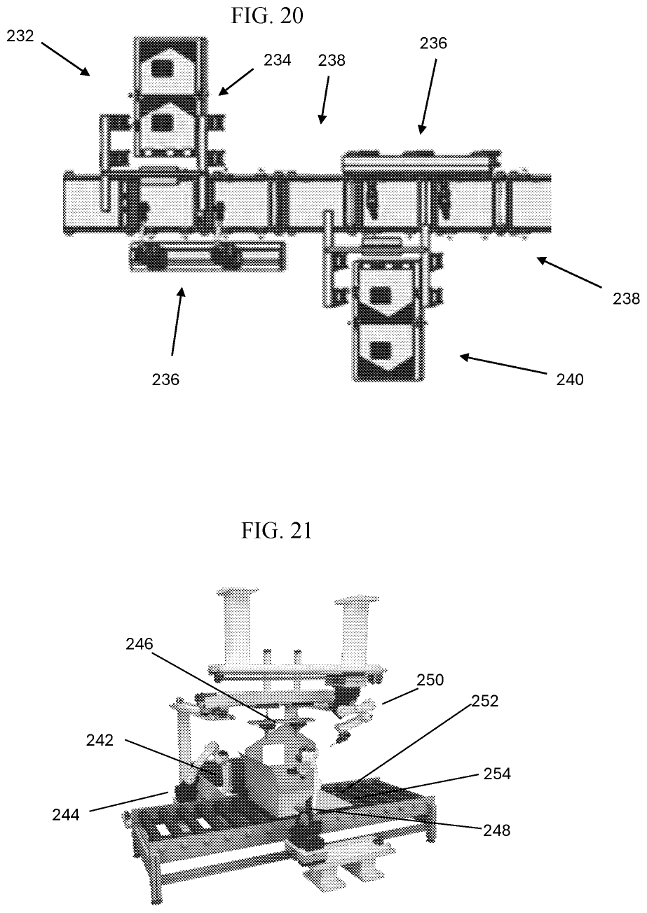

FIG. 20 shows a side sheet weld station 232. This follows the prior station 202 and includes a left side sheet transfer 234, tack welding portions 236, buffer 238, and a right side sheet transfer 240. The side sheet assembly unit shown in FIG. 21 includes a side sheet align 242, corner outside left jig 244, side sheet supply transfer 246, corner outside right jig 248, sheet corner inside point welder 250, centering mechanism 252, and flexible stopper 254. This station prepares and welds side sheets of a small container.

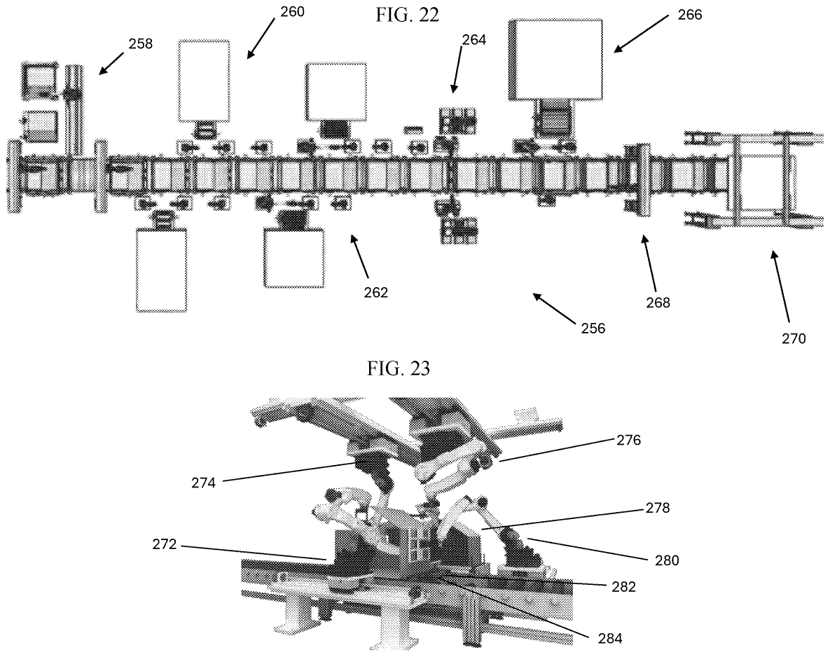

FIG. 22 shows a rear sheet, top sheet, accessory weld and transfer paint station 256. This follows the prior station 232 and includes a rear sheet supply and welding area 258, a fork handle supply and welding area 260, a window frame supply and welding area 262, a plate and rib welding area 264, a top frame supply and tack welding area 266, a top frame welding area 268 and a transfer area 270 to transfer the container to a paint station. Each section of this and other stations include robots for handling and welding the material. This station adds to the container by welding on the rear sheet, top sheet and accessories of a small container.

A rear sheet assembly unit, which is used with the prior station 256, includes an outside jig 272, inside jig 274, rear sheet point weld 276, rear sheet align 278, rear sheet supply 280, centering mechanism 282, and flexible stoppers 284.

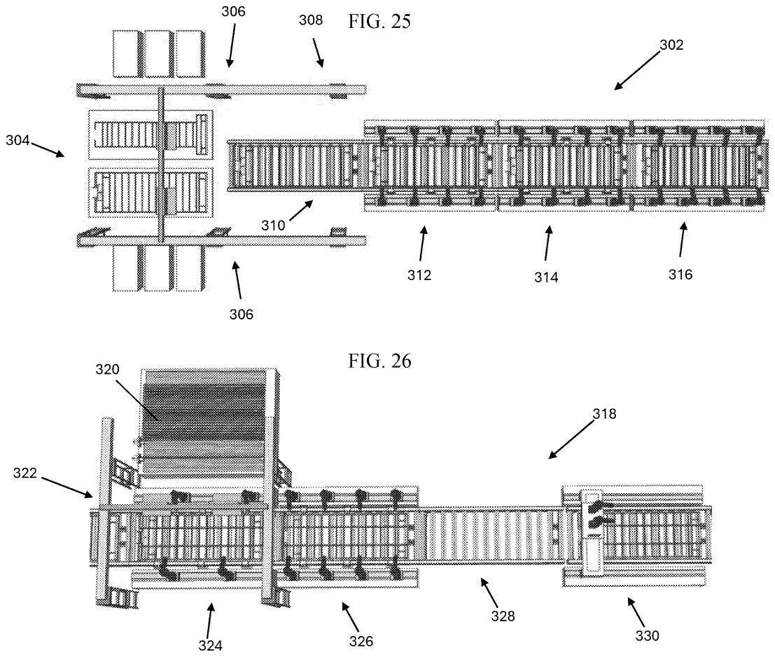

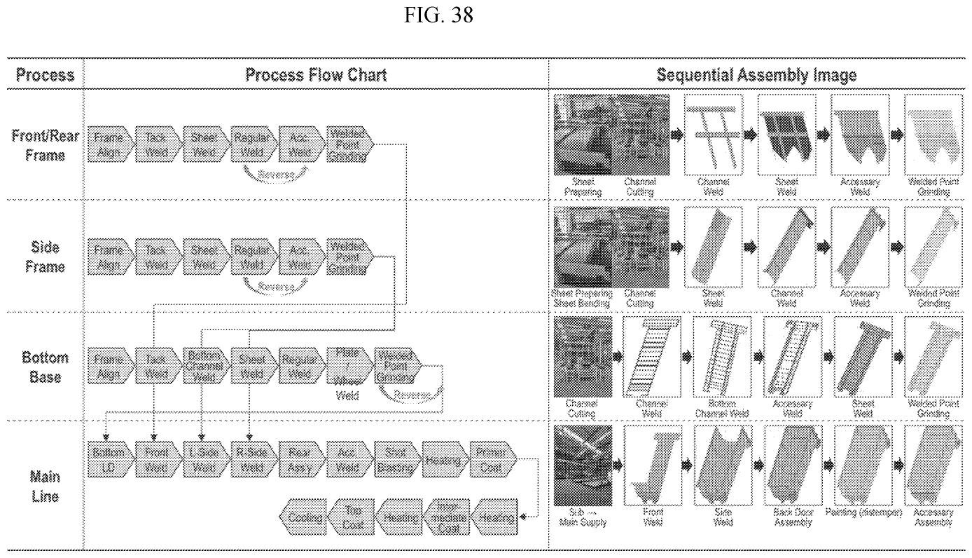

FIGS. 25-38 show an alternative system for manufacturing large containers. FIG. 25 shows a base frame station 302, which includes a base frame point welding area 304 including jigs to improve positioning and shape accuracy, a material deposition area 306 including a material supply stand for production, a base frame transfer area 308 to load base frames, a conveyer 310, a first frame welding area 312 for main point welding, a second frame welding area 314 for even number column welding, and a third frame welding area 316 for odd number column welding. Welding robots are supplied in each welding station.

FIG. 26 shows a base rail and rib station 318 for adding base rails and ribs to a large container. This follows the prior station 302 and includes a rail supply conveyor 320, rail frame transfer 322 to load rail frames, rail frame tack 324 and main 326 weld areas, an inspection area 328 for manual inspection of welds, and a rib welding area 330 for automated supply and welding. It will be understood by those with skill in the art that sensing robots could complete an inspection at the inspection area rather than a manual inspection.

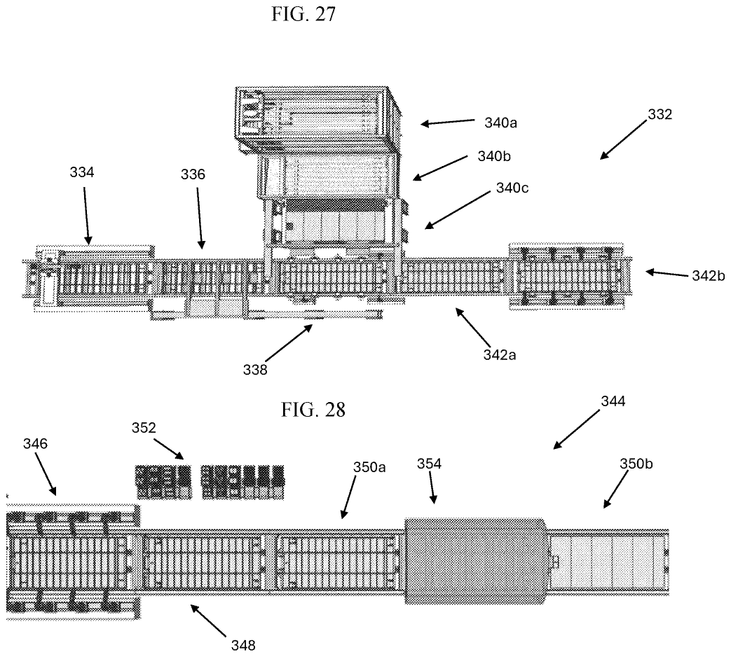

FIG. 27 show a grinding and base plate station 332, which includes a grinding and cleaning area 334, a frame loading area 336, a frame and plate weld area 338 to adjust the frame, align the plate and weld the two, a base plate supply lifter station 340a, a base plate supply buffer 340b, a base plate supply transfer 340c, and tack 342a and main 342b welding areas.

FIG. 28 shows a wheel assembly station 344 for the large container, which includes a grinding and cleaning area 346, wheel assembly and welding area 348, buffer and inspection conveyor 350a, material and parts deposit area 352, base frame assembly reverse turn area 354, and a buffer conveyor 350b. Wheel assembly can be completed as is disclosed in U.S. patent application Ser. No. 19/016,437 filed Jan. 10, 2025, the entire content of which is incorporated herein by reference.

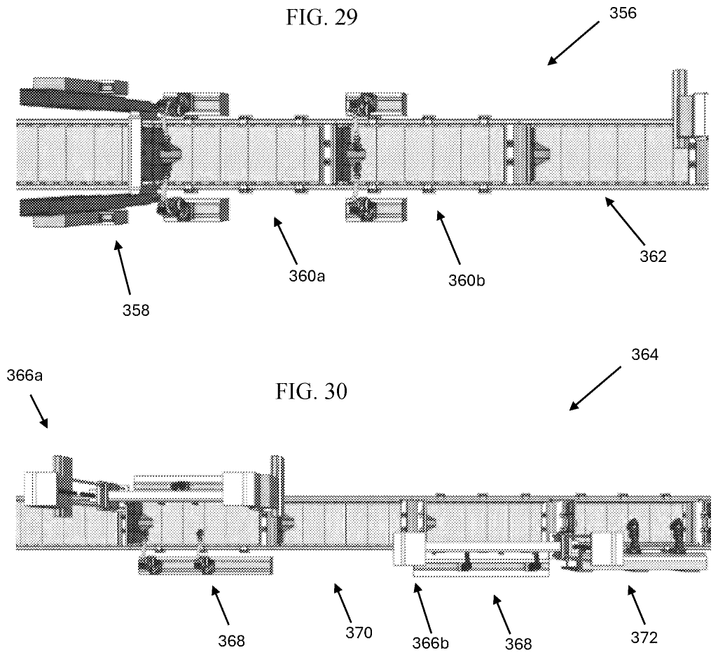

FIG. 29 shows a front wall assembly station 356, which includes a front wall supply unit 358, tack 360a and main 360b welding areas, and a buffer conveyer 362.

FIG. 30 shows a side wall assembly station 364, which includes a left side wall supply unit 366a, a right side wall supply unit 366b, welding areas 368, a buffer conveyor 370, and an inside welding unit 372. This follows the prior station 344 and assembles side walls of the container.

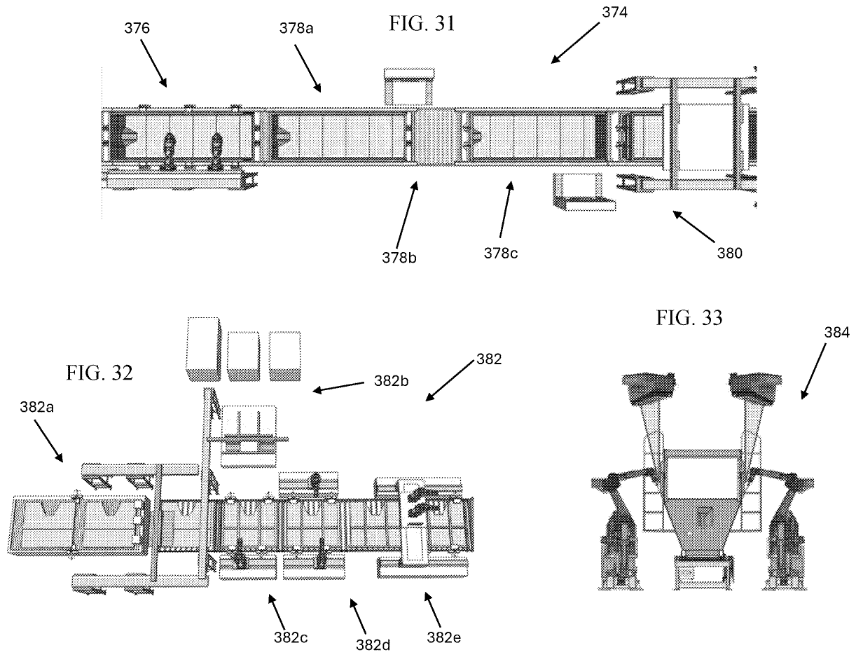

FIG. 31 shows a back door assembly station 374, which includes a grinding and cleaning area 376, a door parts welding and assembly area 378a, a door supply area 378b to supply doors from a manufacturing sub-line, a door accessory welding and assembly area 378c, and a container loading and transfer area 380 to transfer containers to a painting line. As with other stations, this station includes handling robots, which can use suction tools to handle material, conveyors to transfer material, and welding robots to complete welds for the container.

FIGS. 32-37 show supplemental areas to complete assembly of certain components of a large container. FIG. 32 shows a base sheet manufacturing station 382, which includes a base sheet supply area 382a, a square pipe supply and weld area 382b to supply square pipe and weld it into a frame, a loading and welding area 382c to supply a welded square pipe frame to the base sheet for welding, and tack 382d and main 382e welding areas. The completed base sheet with frame is transferred to the main line.

FIG. 33 shows a robotic welding unit 384 with weld sensors to assess the effectiveness and completeness of welding.

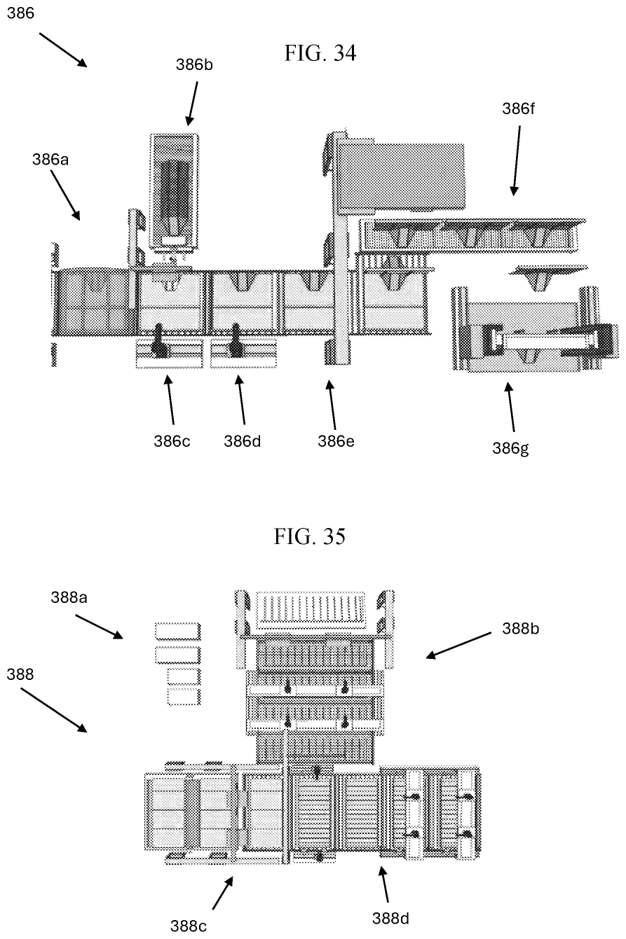

FIG. 34 is a sub-parts manufacturing station 386, which includes an equipment reverser 386a to flit a component 180-degrees for further welding, a sub-parts feeder 386b, a tack welding area 386c, a main welding area 386d, a welding inspection area 386e for inspecting welds with the device of FIG. 33, a buffer area 386f, and a product transfer system 386g. This station assembles and welds portions of a container prior to transfer to the main assembly line where individual components are welded together to form a complete container.

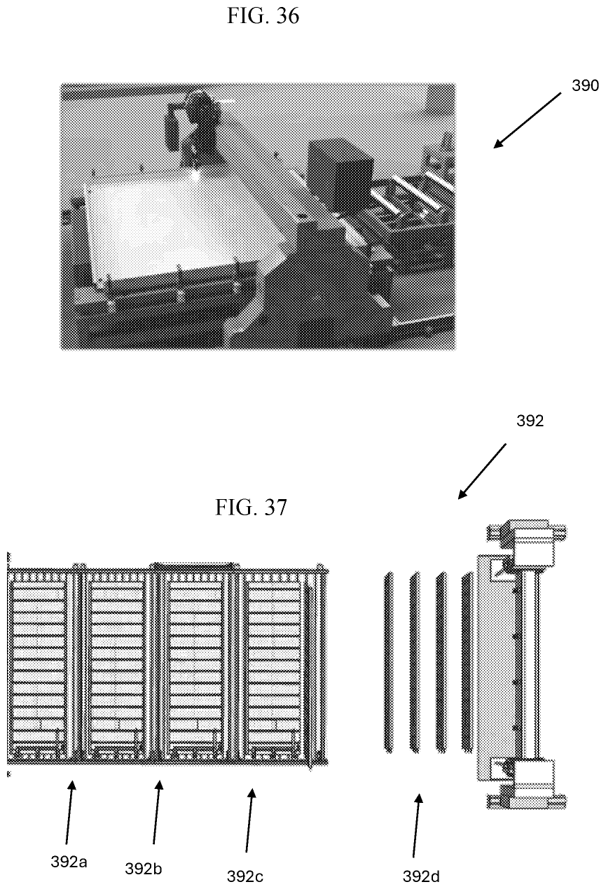

FIG. 35 is a container wall framing and welding station 388, which includes a plurality of welding areas to form a frame and weld the frame to a container wall. There is a square pipe feed area 388a and frame weld areas 388b, a base sheet supply and transfer area 388c, and a frame and sheet weld area 388d to weld the frame to the sheet. In one embodiment, the gantry welding system 390 of FIG. 36 is used for welding.

FIG. 37 shows an accessory assembly station 392, which includes an assembly area 392a, a welding inspection area 392b, buffer area 392c, and transfer area 392d. Accessories such as handles and fork pockets are completed here.

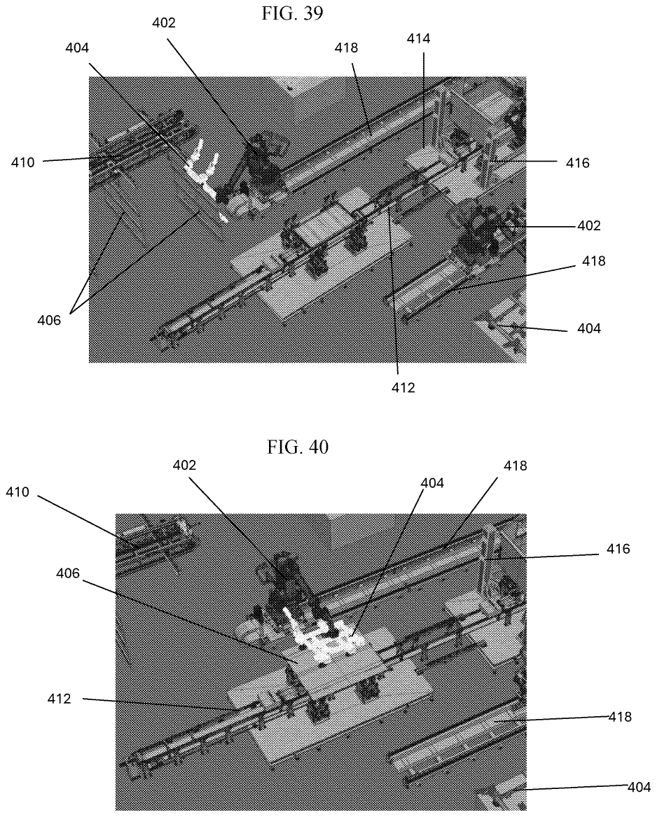

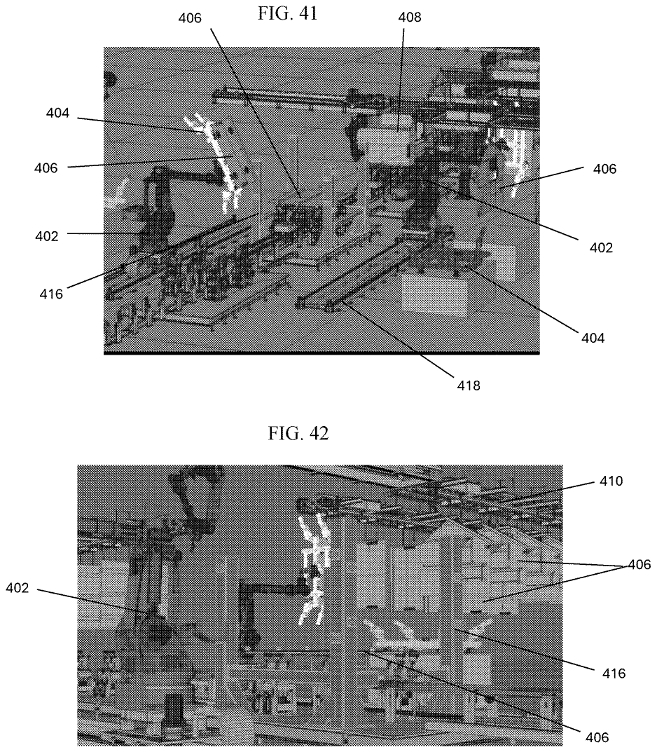

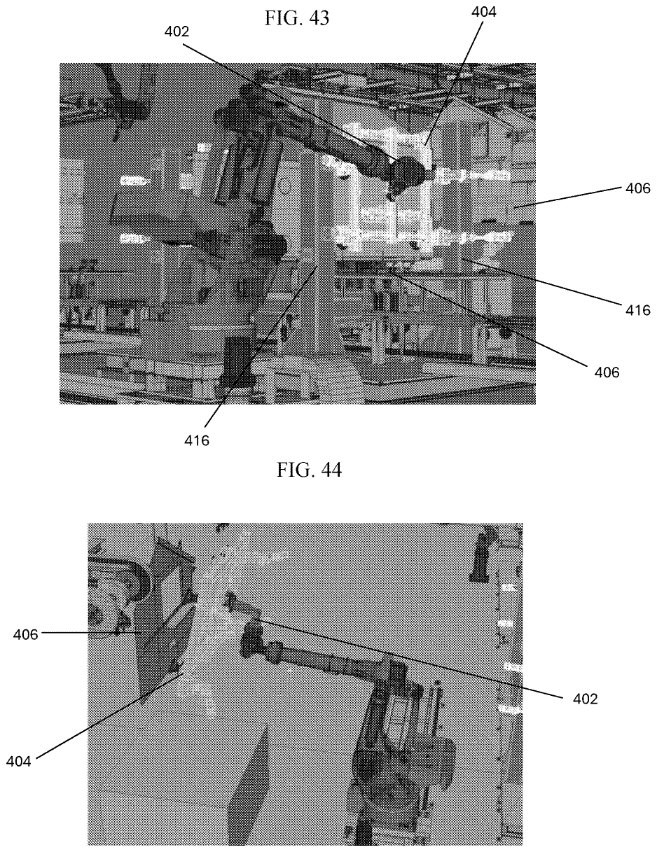

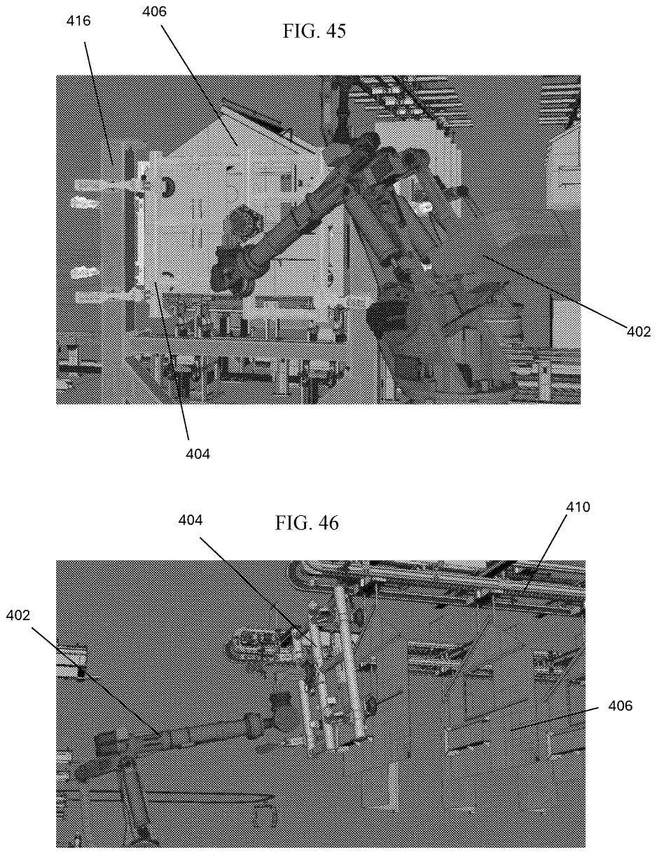

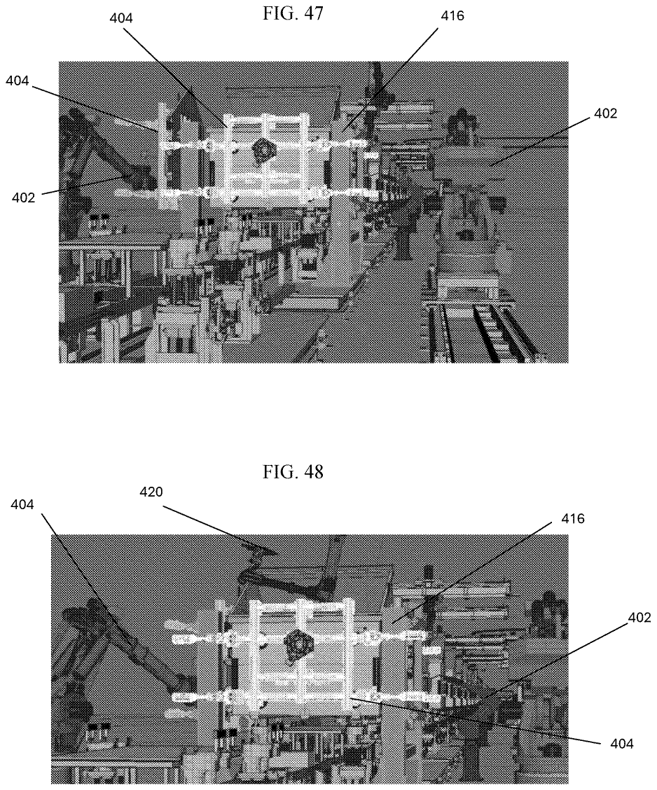

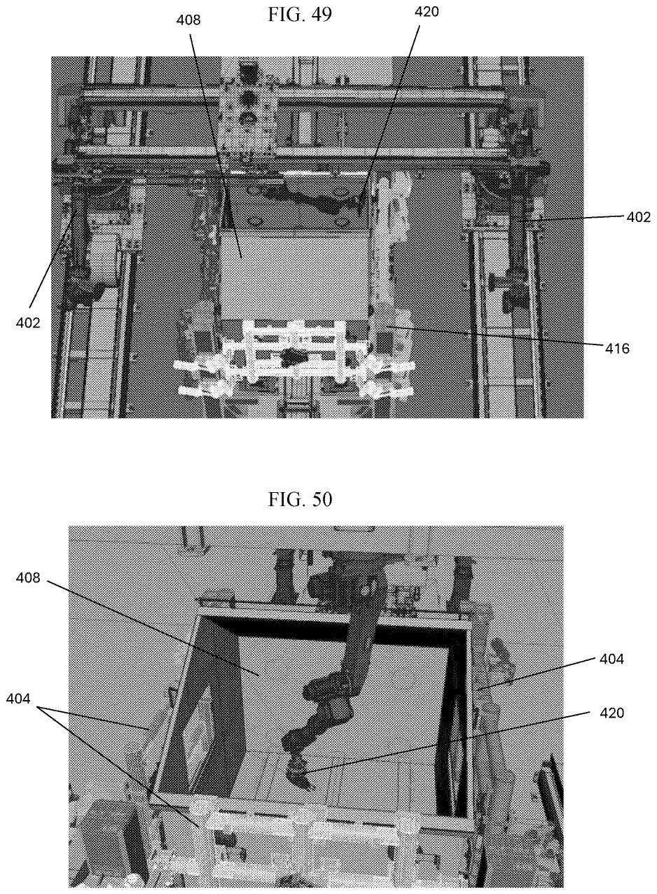

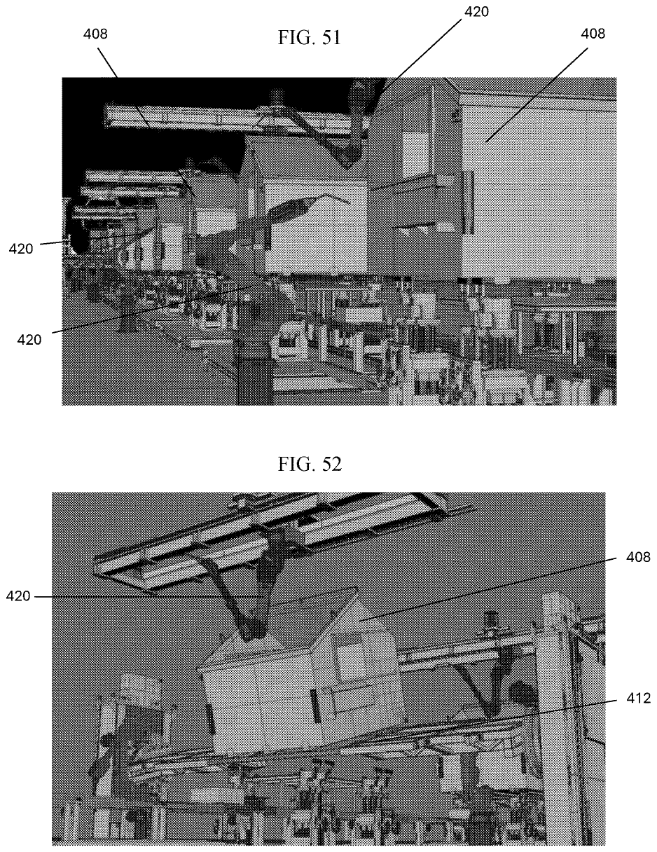

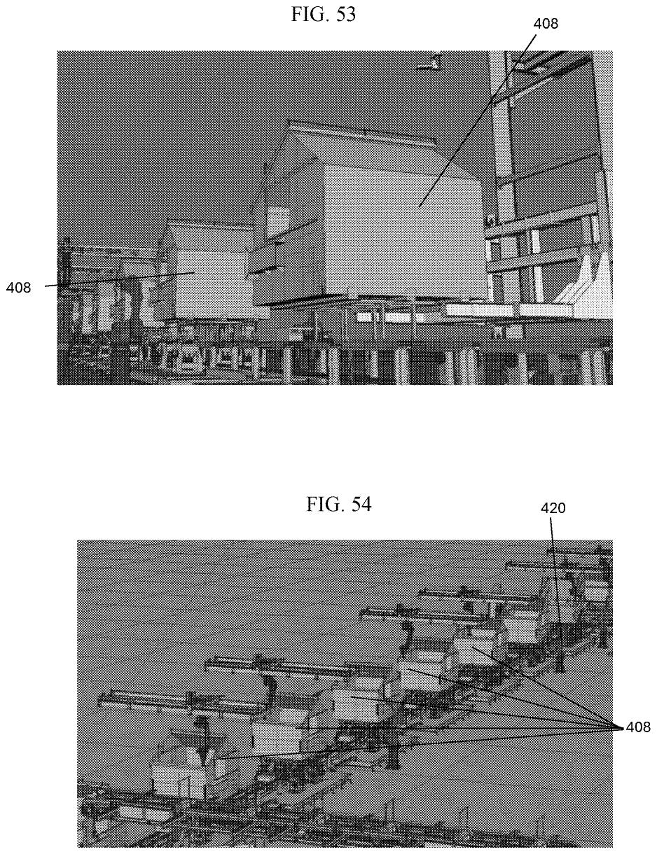

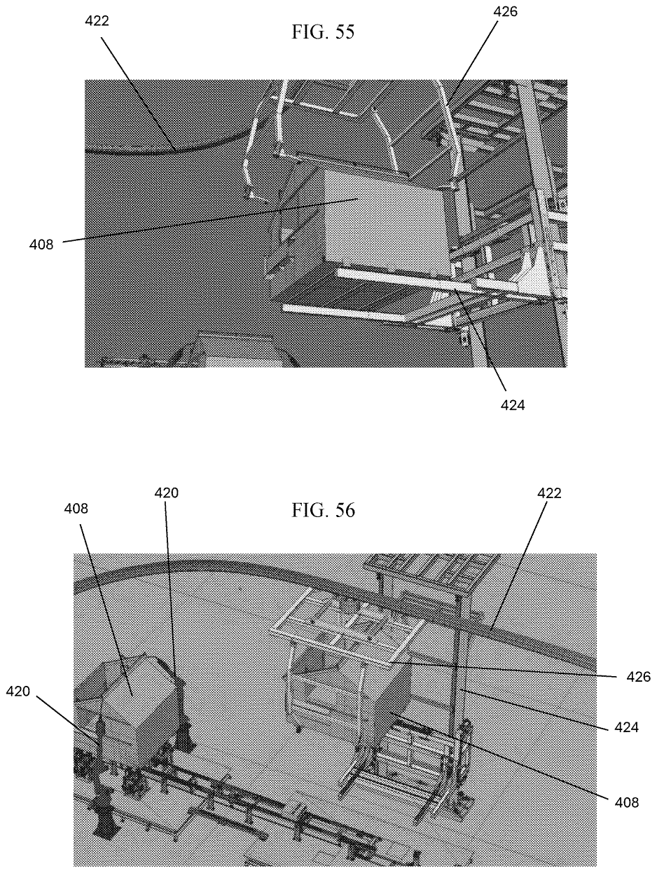

Referring now to FIGS. 39-56, there are shown processes and methods for manufacturing containers as used with the systems disclosed herein. A robotic arm 402 with suction tool 404 secures a floor panel 406 for a container 408, which is provided via a conveyor 410, and places it on a conveyer 412. The floor panel is then transferred to a container staging area 414 where a pair of robotic handling arms 402 assemble a container with suction tools 404 and a framing structure 416. The suction tools are connectable with the framing structure. The robotic arms travel along a track 418 between panel conveyors and the staging area to complete all functions.

Once all panels of a container are connected with the framing structure, a welding robotic arm 420 completes tack welds, such as those shown in FIGS. 16 and 17 for small and large containers, respectively. The suction tools 404 are then removed from the framing structure and the container is transferred via the conveyor 412. Further welding robots complete main welds on the container along all points of connection between floor panels, side panels, roof panels and accessories. Sensing robots assess welds to ensure all are proper. Any welds that are not complete are re-welded. The conveyor system 412 is pivotable to provide for sufficient accessibility of welding robots, as shown in FIG. 52.

Once all welds are complete and the container is ready for transfer to the warehouse for housing and shipping. The container is lifted to a separate conveyer 422 via a transfer tower 424 and claw 426.

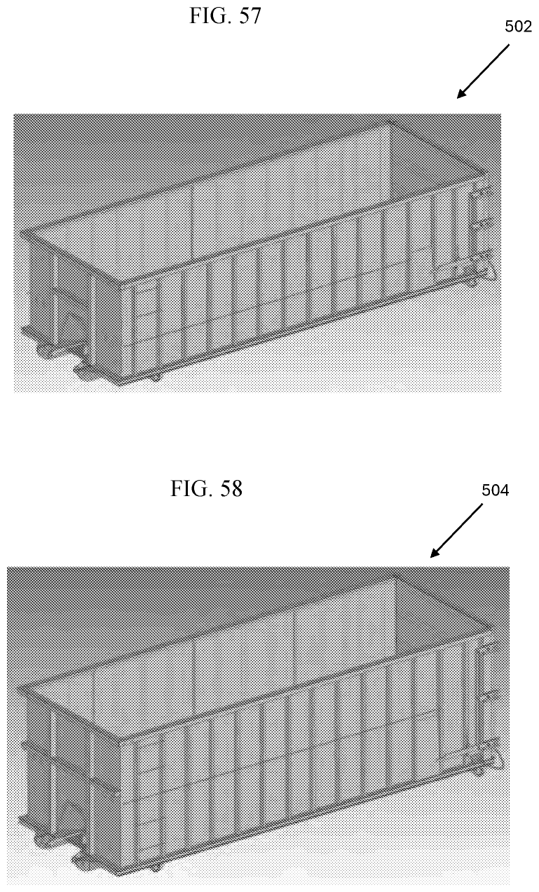

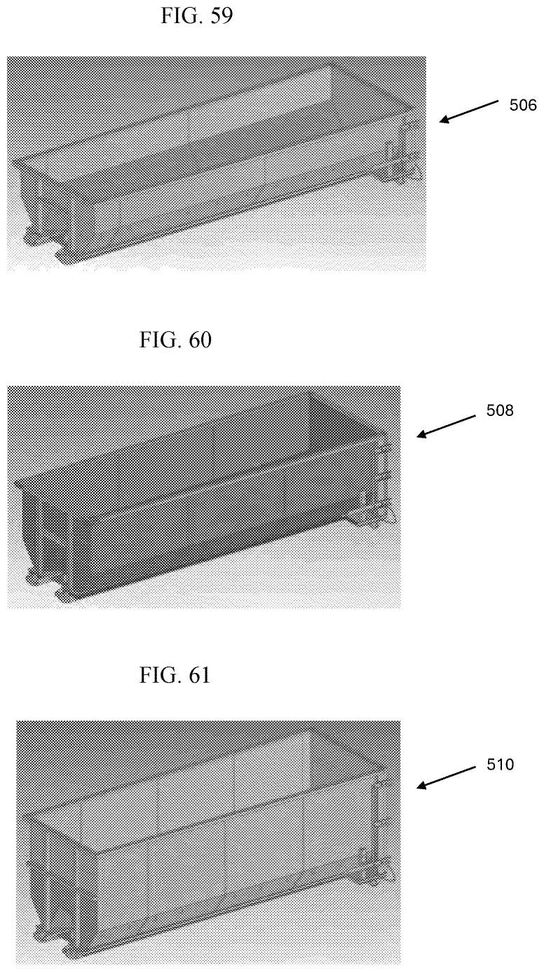

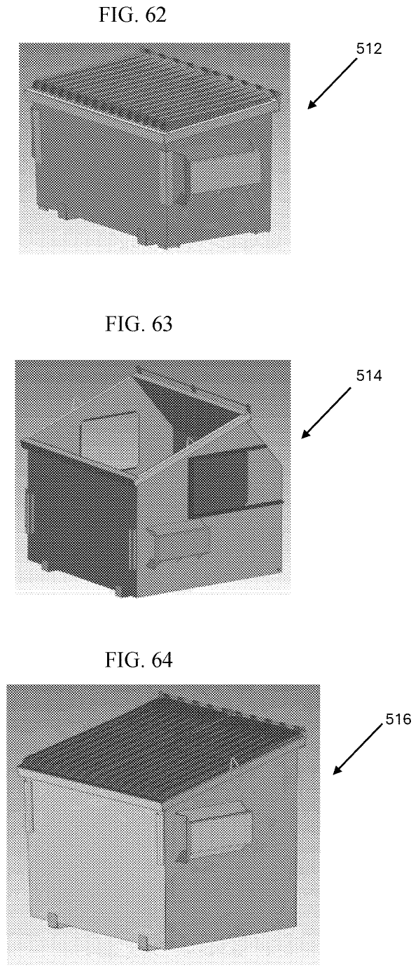

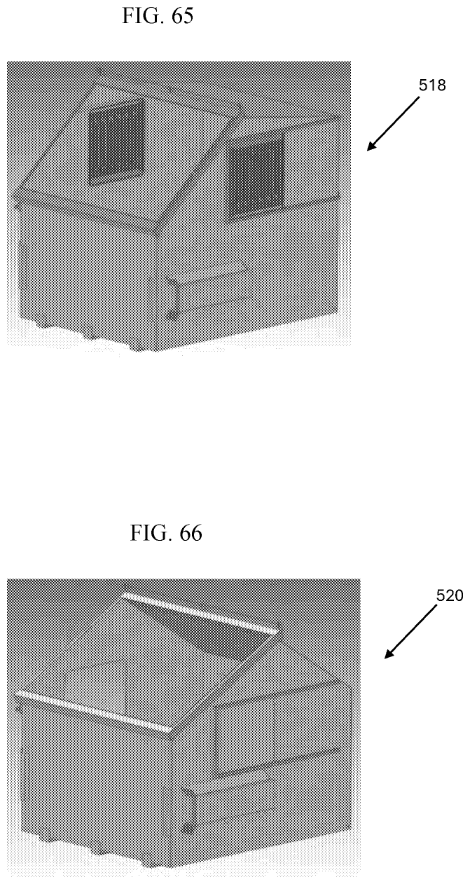

FIGS. 57-66 show examples of large containers 502, 504, 506, 508, 510 and small containers 512, 514, 516, 518, 520 that can be manufactured with the systems and methods described herein.

It will be understood by those with skill in the art that containers other than waste containers could be manufactured with the methods disclosed herein.

Although the above description references particular embodiments, it is to be understood that these embodiments are merely illustrative of the principles and applications of the present disclosure. It is therefore to be understood that numerous modifications may be made to the illustrative embodiments and that other arrangements may be devised and employed without departing from the spirit and scope of the present disclosure.

1. An automated container manufacturing system, comprising a plurality of component manufacturing sections, a container assembly section, and a container welding section, wherein the component sections include at least one robotic assembly arm and at least one robotic welding arm for forming container walls, the assembly section includes at least one robotic assembly arm and robotic welding arm for assembling and welding container walls to each other to form a container, and the welding section includes at least one robotic assembly arm for welding sections of a container.

2. The automated container manufacturing system as defined in claim 1, wherein the component manufacturing sections includes a side wall section and floor section, each of the side wall section and floor section including at least one handling robot and at least one welding robot configured to assemble and weld portions of container side walls and floors, respectively.

3. The automated container manufacturing system as defined in claim 1, wherein the welding robots of the container assembly section are configured to form tack welds.

4. The automated container manufacturing system as defined in claim 1, wherein the container welding section includes at least two welding stations, each station including at least one robotic assembly arm and at least one robotic welding arm, the two stations having a conveyer arranged therebetween for moving a container from one station to the other station.

5. The automated container manufacturing system as defined in claim 1, wherein the welding section includes a sensing station configured to scan a container for incomplete welded portions.

6. A method and system for automated assembly of containers having at least a bottom wall and plurality of side walls includes:
a. a first robotic device configured to cut at least one sheet of metal into a bottom wall and a plurality of side walls;
b. a second robotic device configured to arrange the bottom wall and plurality of side walls in spaced relation relative to desired construction of a container;
c. a third robotic device configured to connect the container bottom wall with the plurality of side walls;
d. a fourth robotic device configured to scan and analyze the connected walls to determine whether the walls are arranged accurately and securely connected.

7. The method and system of claim 61, further including an additional robotic device configured to complete finishing welds for the container.

8. The method and system of claim 61, further including at least one additional robotic device configured to clean the surfaces of the container.

9. The method and system of claim 83, further including at least one additional robotic device configured to paint or powder coat the surfaces of the container.

10. The method and system of claim 94, wherein the at least one additional robotic device is further configured to apply heat to the container.

11. The method and system of claim 61, the container including a bottom wall, a pair of side walls, an operable rear wall and an operable ramp wall.
